(19) United States
(12) Patent Application Publication
(10) Pub. No.: US 2007/0113105 A1
(43) Pub. Date: May 17, 2007

(54) Apparatus and method for power management in peripheral device

(76) Inventors: William B. Campbell, Beaverton, OR (US); Monica Livingston, Raleigh, NC (US); Stewart Gilbert, Hillsboro, OR (US); Katsutoshi Handa, Beaverton, OR (US); Vijay Oks, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/280,878

(22) Filed: Nov. 15, 2005

(51) Int. Cl. G06F 1/26

(52) U.S. Cl. 713/300

(57) ABSTRACT

In one embodiment, an apparatus and method for reducing power consumption in a peripheral device when the peripheral device is not connected to a transmission medium.

### FIELD

Embodiments of the invention relate generally to power management systems and more specifically to power management of peripheral devices

### BACKGROUND

Commercial markets and technological advances have created the need for power management in processing devices. The convergence of communications, computing, and entertainment onto mobile devices has led to higher levels of silicon integration on smaller, more cost-effective processors. Processor performance also continues to increase as the size of transistors decreases, as predicted by Moore's law. Thus, devices demand rising power requirements.

Many devices use batteries to power their processors. Having a more limited source of power, power management in battery powered processor devices is of the utmost importance. Historically, power consumption has been managed through approaches such as clock gating, dynamic voltage and frequency scaling (DVFS), the use of processors with low power requirements, managing leakage, and the use of low power modes when some functionality of a device is not required.

When low power modes such as a “sleep modes” are used to manage power consumption of a device, a system must be in place to restore power when some functionality of the device needs to be reinstated. For example, Alert on LAN (AOL) and Wake on LAN (WOL) are current methods used to “turn on” a LAN controller that is in a low power mode. Restoring power using AOL and WOL require the LAN controller to receive specially encoded packets from a remote link partner. Unfortunately, detecting these specially encoded packets requires a significant amount of logic. Hence, a corresponding amount of power must be consumed by the LAN device's circuitry itself in order to detect the possible arrival of the special incoming packets.

Conventional computer architectures include a host CPU, main memory, and I/O interfaces to connect to peripheral devices. Not only does the host CPUs power consumption need to be managed but so do the processor devices associated with I/O interfaces.

One commercially accepted standard for reducing power consumption in PCs is known as Advanced Power Management (APM) BIOS Interface Specification Revision 1.0, first released in January 1992. APM uses control that resides in the PC BIOS and defines four power states (Enable, Standby, Suspend, Off). A device is powered down based on activity timeouts. The standard allows for broad power management decisions without knowledge of the OS or individual applications.

Another exemplary standard is the Advanced Configuration and Power Interface (ACPI) Specification, first released in December, 1996. ACPI was designed to overcome some of the drawbacks of APM. In ACPI, control is divided between the BIOS and OS. Because decisions are managed through the OS, this specification is applicable to general purpose computers with standard usage and hardware.

The power save modes described in APM and ACPI adjust the amount of power delivered to a device depending on the present demand for functionality of the device. Unfortunately, under current power management methods like APM and ACPI, power must be delivered to processor devices even in the highest power save mode.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a block diagram of one embodiment of a computer system;

FIG. 2 illustrates a block diagram of one embodiment of a peripheral device;

FIG. 3 illustrates a block diagram of an alternative embodiment of a peripheral device;

FIG. 4 is a flow diagram of one embodiment of a process for power management in a peripheral device;

FIG. 5 illustrates a block diagram of one embodiment of a power management system; and

FIG. 6 illustrates a block diagram of an alternative embodiment of a power management system;

FIG. 7 illustrates a circuit diagram of a link detection circuit.

### DESCRIPTION OF EMBODIMENTS

A method and apparatus for decreasing power consumption in a peripheral device are described. In the following description, for purposes of explanation, numerous specific details are set forth in order to provide a thorough understanding of the present invention. It will be apparent, however, to one skilled in the art that the present invention can be practiced without these specific details.

Some portions of the detailed descriptions that follow are presented in terms of algorithms and symbolic representations of operations on data bits within a computer system's registers or memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions using terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

Other embodiments of the present invention can be accomplished by way of software. For example, in some embodiments, the present invention may be provided as a computer program product or software which may include a machine or computer-readable medium having stored thereon instructions which may be used to program a computer (or other electronic devices) to perform a process according to the present invention. In other embodiments, processes of the present invention might be performed by specific hardware components that contain hardwired logic for performing the processes or by any combination of programmed computer components and custom hardware components. Thus, a machine-readable medium may include any mechanism for storing or transmitting information in a form readable by a machine (e.g., a computer), but is not limited to, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

In the following detailed description of the embodiments, reference is made to the accompanying drawings that illustrate, by way of illustration, specific embodiments in which the invention may be practiced. In the drawings, like numerals describe substantially similar components throughout the several views. These embodiments are described in sufficient detail to enable those skilled in the art to practice the invention. Other embodiments may be used and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

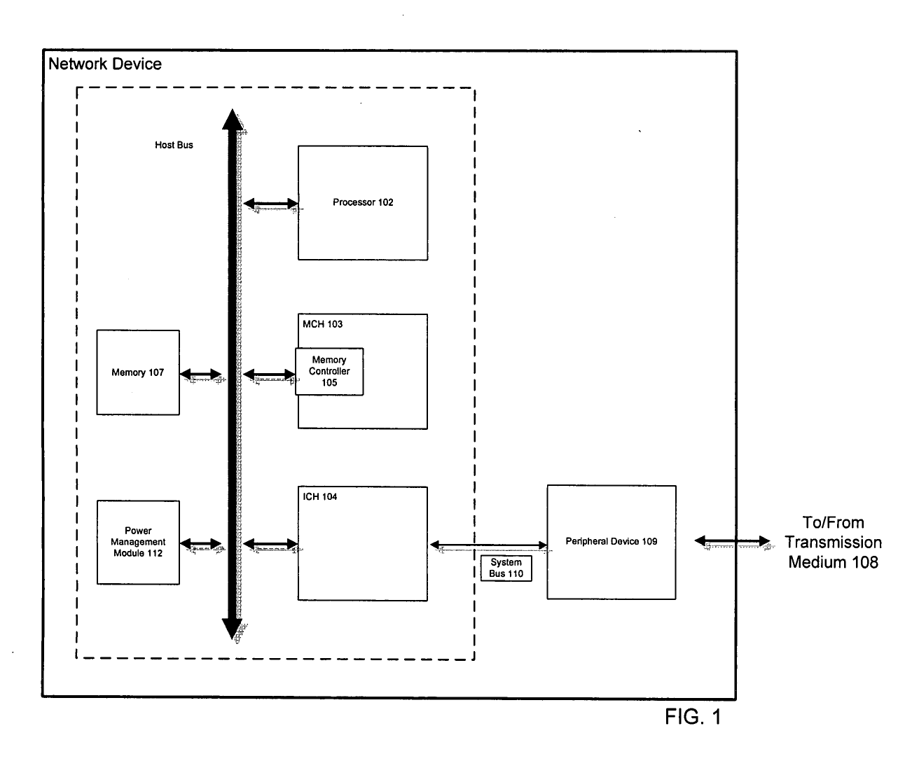

FIG. 1 shows a diagrammatic representation of a machine in the exemplary form of a computer system 100 within which embodiments of the present invention may operate. The computer system 100 may operate as a standalone device or may be connected (e.g., networked) to other machines. In a networked deployment, the computer system 100 may operate in the capacity of a server or a client machine in server-client network environment or as a peer machine in a peer-to-peer (or distributed) network environment. The network may be implemented using a variety of protocol architectures (e.g., Ethernet, token ring or asynchronous transfer mode (ATM)). The computer system 100 may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

The computer system 100 includes a processor 102 (e.g., a central processing unit (CPU)), a memory controller hub 103 (MCH), and an I/O controller hub 104 (ICH) to facilitate memory and I/O transactions. The MCH 103 uses a memory controller 105 and a memory 107 (e.g., read only memory (ROM), flash memory, dynamic random access memory (DRAM) such as synchronous DRAM (SDRAM) or Rambus DRAM (RDRAM), static random access memory (SRAM), etc.) to execute memory transactions. The ICH 104 communicates with peripheral device 109.

The memory 107 includes a machine-readable medium on which is stored one or more sets of instructions embodying any one or more of the methodologies or functions described herein. The software may also reside, completely or at least partially, within the processor 102 during execution thereof by the computer system 100.

The software may further be transmitted or received over a transmission medium 108 via a transmission medium interface (not shown).

While the machine-readable medium is described in an exemplary embodiment to be a single medium, the term “machine-readable medium” should be taken to include a single medium or multiple media (e.g., a centralized or distributed database and/or associated caches and servers) that store the one or more sets of instructions. The term “machine-readable medium” shall also be taken to include any medium that is capable of storing, encoding, or carrying a set of instructions for execution by the machine and that causes the machine to perform any one or more of the methodologies of the present invention. The term “machine-readable medium” shall accordingly be taken to include, but not be limited to, solid-state memories, optical and magnetic media, and carrier wave signals.

The computer system 100 may further include peripheral devices (e.g. a video display unit, an alphanumeric input device (e.g., a keyboard), a cursor control device (e.g., a mouse), a disk drive unit, a signal generation device (e.g., a speaker) and a network interface device). The peripheral devices are coupled to the system bus 110 through a data bus and bridge. The system bus may be a peripheral components interconnection (PCI) bus or universal serial bus (USB). However, these are merely examples of the bus and embodiments of the present invention are not limited in this respect.

Referring to FIG. 1, in one embodiment, a peripheral device 109 transmits data to and/or from a transmission medium 108. The transmission medium 108 may be any one of several transmission media suitable for transmitting data according to a communication protocol including, for example, coaxial cabling, category five cabling, twisted pair lines, optical transmission media, or wireless transmission media.

The peripheral device 109 may be adapted for transmitting data through the transmission medium 108 according to a protocol such as, for example, Ethernet (e.g. 10Base-T, 100Base-TX, 1000Base-T, 100Base-T4 or Gigabit Ethernet GbE)), digital subscriber line (DSL) protocols, wireless communication protocols, Infiniband, universal serial bus (USB) protocols, home phoneline networking alliance (HPNA) protocols, synchronous optical network (SONET), token ring protocols, ATM protocols, or digital cable transmission protocols.

According to an embodiment, the peripheral device 108 may transmit data received from the transmission medium 108 to the processor 102 and memory 107 as inputs to processes hosted on the processor 102 and memory 107. Similarly, processes hosted on the processor 102 and memory 107 may forward data to the peripheral device 109 to be transmitted through the transmission medium 108.

According to an embodiment, the computer system 100 includes a power management module 112 for managing power in the peripheral device 109. In particular, the power management module 112 may detect that an integrated circuit of the peripheral device 109 used to communicate with the transmission medium 108 no longer requires power and cause the integrated circuit to be completely powered down in order to reduce power consumption. Subsequently, when the transmission medium 108 is reconnected to the peripheral device 109 and the services of the integrated circuit of the peripheral device 109 are required, the power management module 112 may cause power to be supplied to the integrated circuit, so that communication via the transmission medium 108 may resume. In one embodiment, the power management module 112 resides in memory 107 and contains processing logic for execution (e.g., BIOS or driver code) by the processor 102. In another embodiment, the power management module 112 contains processing logic that comprises hardware such as circuitry, dedicated logic, programmable, logic, microcode, etc. In yet another embodiment, the power management module 112 contains processing logic that comprises a combination of software and hardware.

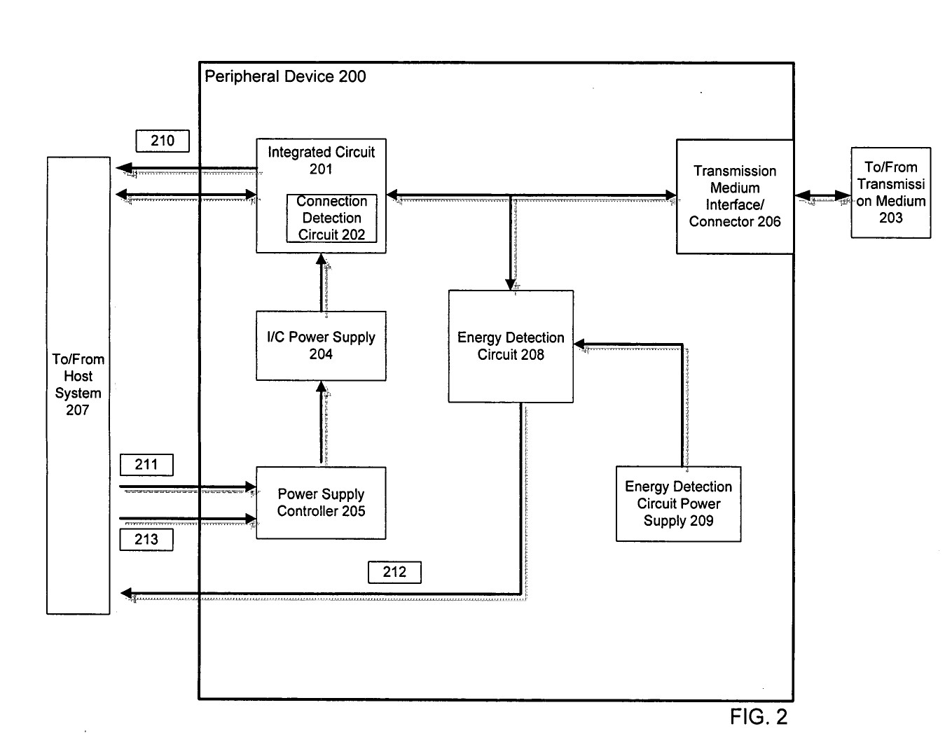

FIG. 2 illustrates a block diagram of one embodiment of a peripheral device 200 utilizing power management. The peripheral device 200 includes an integrated circuit 201 coupled to a transmission medium 203 via a transmission medium interface connector 206 (e.g., RJ-45). The integrated circuit 201 may be for example a LAN controller. In one embodiment, the integrated circuit 201 includes a connection detection circuit 202 to detect whether the integrated circuit 201 is coupled to transmission medium 203.

The integrated circuit 201 is coupled to an integrated circuit power supply 204 and a power supply controller 205. The integrated circuit 201 is also coupled to the host system 207 to at least exchange communication related data and power management related data.

The integrated circuit is further connected to an energy detection circuit 208, which is connected to an energy detection circuit power supply 209. The energy detection circuit 208 detects whether energy is present on the connection between the integrated circuit 201 and the transmission medium interface connector 206. The energy may be detected by, for example, detecting the voltage level on the medium dependent interface (MDI) signals.

In an embodiment, the energy detection circuit 208 runs on less power than would be required to run the integrated circuit 201 or the connection detection circuit 202 on the integrated circuit 201.

In one embodiment, when the connection detection circuit 202 detects that the integrated circuit is no longer connected to the transmission medium 203, the connection detection circuit 202 issues a signal 210 to the host system 207.

In order to accommodate short periods of disconnection from the transmission medium 206, the host system 207 may wait for a predefined period of time before powering down the integrated circuit 201 (e.g., 5-10 min). After the predetermined period of time, the host system 207 may issue a signal 211 that completely powers off the integrated circuit 201 via the integrated circuit power supply controller 205.

When the integrated circuit 201 is powered off, the connection detection circuit 202 of the integrated circuit is not operable to detect when the integrated circuit 201 is reconnected to the transmission medium 203. Instead, the energy detection circuit 208 detects when the connection between the integrated circuit 201 and the transmission medium 203 has been re-established and issues a signal 212 to the host system 207 indicating that this connection has been re-established. In response, the host system 207 issues a signal 213 that causes the integrated circuit 201 to be powered on.

Because the energy detection circuit 208 may require less power to run than the integrated circuit 201 or the connection detection circuit 202 embedded in integrated circuit 201, the use of the energy detection circuit 208 reduces power consumption by the peripheral device 200. In addition, because the integrated circuit 201 does not require a special signal to be turned back on, less circuitry is required compared to prior art “turn on” methods.

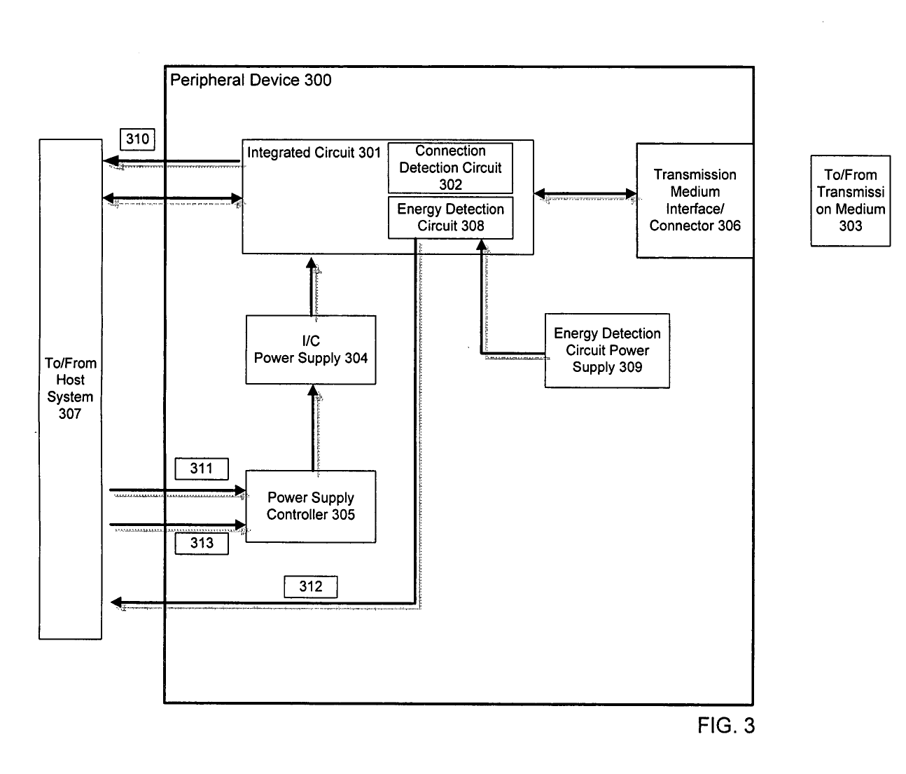

FIG. 3 is a block diagram of an alternative embodiment of a peripheral device 300. The peripheral device 300 includes an integrated circuit 301 that contains both a connection detection circuit 302 and an energy detection circuit 308. The connection detection circuit 302 is only functional when the integrated circuit 301 is receiving power from the integrated circuit power supply 304. The energy detection circuit 308 is coupled to the energy detection power supply and as such remains operable even when the integrated circuit 301 is no longer receiving power from the integrated circuit power supply 304. The energy detection circuit 308 runs on less power than would be required to run the entire integrated circuit 301 or the connection detection circuit 302 on the integrated circuit 301. Thus, power consumption can be decreased when the integrated circuit 301 is not connected to the transmission medium 303. In addition, because the integrated circuit 301 does not require a special signal to turn back on, less circuitry is required compared to prior art “turn on” methods.

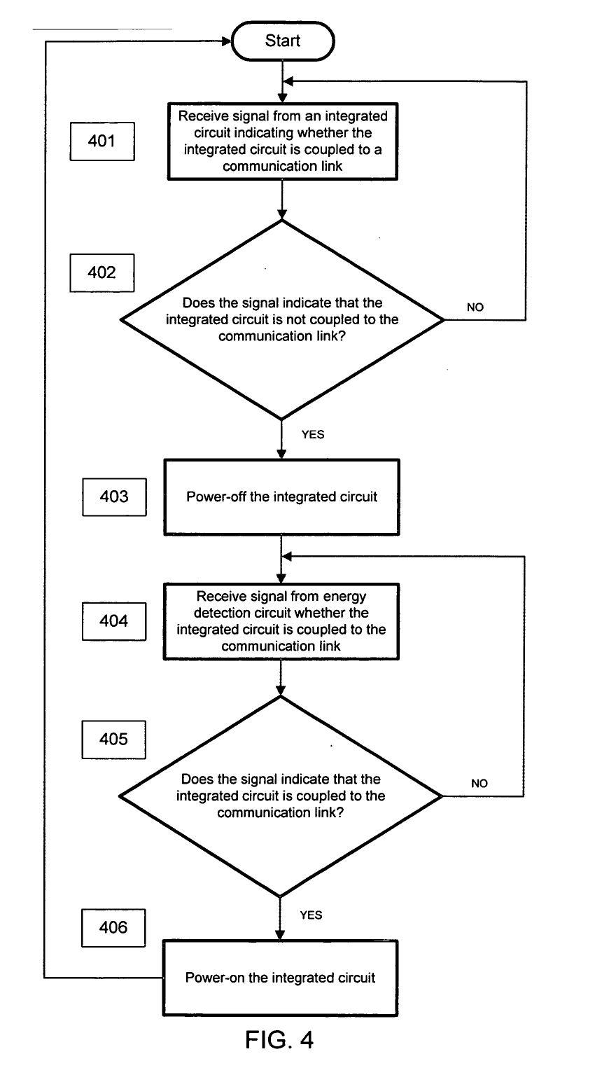

FIG. 4 is a flow diagram of one embodiment of a process 400 for power management in a peripheral device. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 400 is performed by a power management module 112 of FIG. 1.

In FIG. 4, process 400 starts with processing logic receiving a signal from the integrated circuit (processing block 401). The signal from the integrated circuit indicates whether or not the integrated circuit is coupled to a transmission medium. If the determination made by processing logic at processing block 402 is negative, the sequence is repeated beginning at processing block 401. If the determination is positive, then processing logic at processing block 403 causes integrated circuit to be powered off. In particular, in one embodiment, processing logic may signal a power supply controller to cause power to be removed from the integrated circuit. The sequence continues when processing logic receives a signal from energy detection circuit (processing block 404). The signal from energy detection circuit indicates whether or not integrated circuit is coupled to transmission medium. If the determination made by processing logic at processing block 405 is negative, the sequence is repeated beginning at processing block 404. If the determination is positive, processing logic at processing block 406 causes integrated circuit to be powered on. In particular, in one embodiment, processing logic may signal a power supply controller to cause power to be delivered to the integrated circuit.

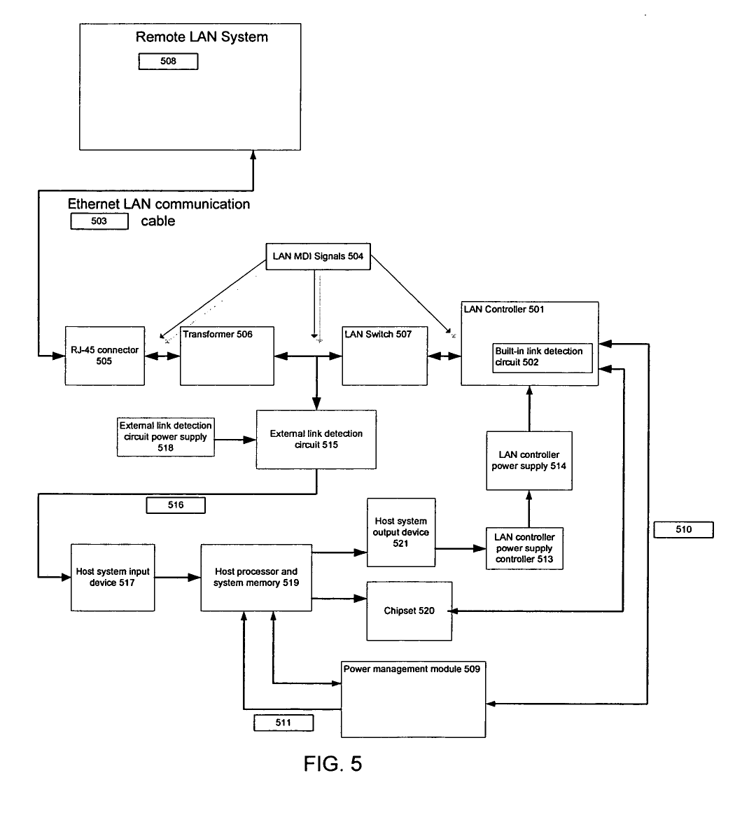

FIG. 5 is a block diagram of one embodiment of a power management system 500. Power management system 500 includes a LAN controller 501 that has a built-in link detection circuit 502. When the LAN controller 501 is powered on, the built-in link detection circuit 502 detects when the Ethernet LAN 503 has been disconnected from RJ-45 connector 505 and the LAN controller 501.

In one embodiment, LAN MDI signals 504 arrive at the LAN controller 501 from a remote LAN system 508 via the RJ-45 connector 505, a transformer 506 normalizing transmission signals, and a LAN switch 507.

The built-in link detection circuit 502 may detect the presence of an Ethernet LAN 503 connection by sensing whether MDI signals 504 are present on the connection between the LAN controller 501 and the RJ-45 port 505.

Upon disconnection from the Ethernet LAN 503, the LAN controller 501 issues a signal 510 to a power management module 509. In one embodiment, the power management module 509 resides in a host system to control power delivery to the LAN controller. Upon receiving the signal 510, the power management module 509 starts a counter in a timer. Periodically, the power management module may determine whether the Ethernet LAN 503 connection is still down. The periodic check may be implemented with a call back function. Once the counter reaches the predefined period of time, the power off process is triggered. In particular, the power management module 509 issues a signal 511 that causes the LAN controller 510 to be completely powered off via the LAN controller power supply controller 513 and the LAN controller power supply 514.

When the LAN controller 501 is powered off, the built-in link detection circuit 502 is not operable to detect the Ethernet LAN 503 connection but the external link detection circuit 515 is operable to detect the Ethernet LAN connection. If the external link detection circuit 515 determines that the Ethernet LAN connection has been reestablished, it issues a signal 516 to the host system input device 517. In response, the power management module 509 causes the LAN controller 501 to be powered up.

Because the external link detection circuit 515 may require less power to run than the integrated circuit 501 or the built-in link detection circuit 502 embedded in integrated circuit 501, the use of the external link detection circuit 515 reduces power consumption by the LAN controller. In addition, because the integrated circuit 501 does not require a special signal to turn back on, less circuitry is required compared to prior art “turn on” methods.

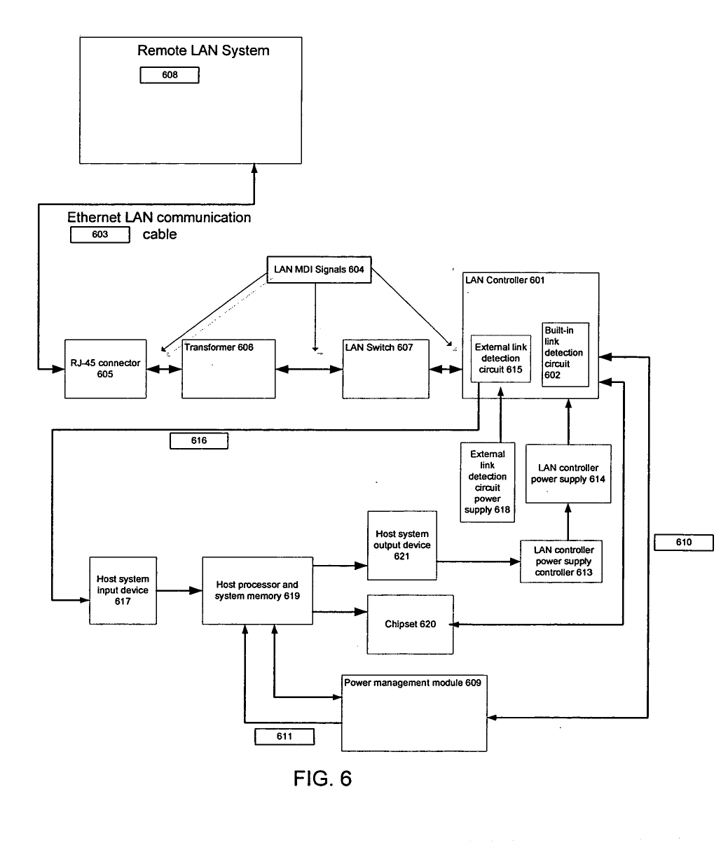

FIG. 6 is a block diagram of an alternate embodiment of a power management system. Referring to FIG. 6, the LAN controller 601 may comprise both the built-in link detection circuit 602 and the external link detection circuit 615. In this embodiment, the built-in link detection circuit 602 is only functional when the LAN controller 601 is receiving power from the LAN controller power supply 614. The external link detection circuit 615 remains operable even when the LAN controller 601 is no longer receiving power from the LAN controller power supply 614. The external link detection circuit 615 runs on less power than would be required to run the entire LAN controller 601 or built-in link detection circuit 602 on the LAN controller 601. Thus, power consumption can be significantly decreased if the external signal detector 615 is used. In addition, because the integrated circuit 601 does not require a special signal to turn back on, less circuitry is required compared to prior art “turn on” methods.

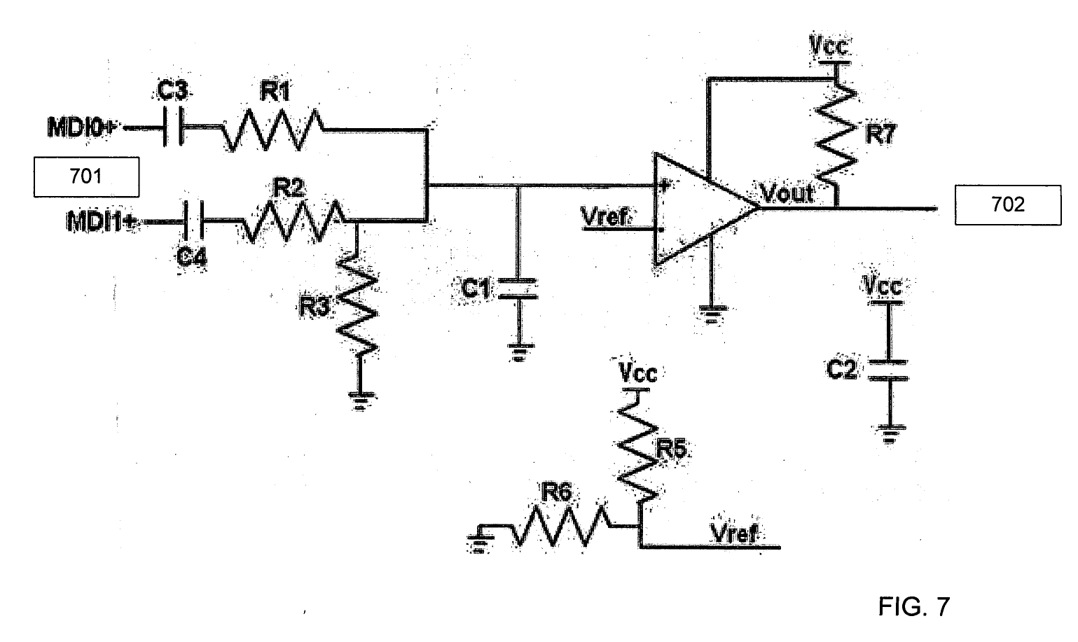

FIG. 7 is a circuit diagram of a link detection circuit 700. In an embodiment, the link detection circuit 700 is used to detect MDI signals via an MDI interface 701. The link detection interface 701 includes communication interface signals MDI0+ and MDI1+. C3 and C4 of link detection circuit 700 provide DC isolation while large R1 and R2 values may minimize loading of the MDI interface 701. In an embodiment, C1 may also be used with R1 and R2 to widen comparator input pulses. R5 and R6 may be used to set a noise rejection voltage level. Relatively large values of R5, R6, and R7 may be used to minimize overall power consumption of link detection circuit 700. The signal at Vₒᵤₜ 702 is used to control the power to an integrated circuit (e.g. LAN controller).

To facilitate link detection, the link detection circuit 700 may include a noise “squelch” (noise ignore) feature provided by a DC voltage divider of the circuit's comparator. Additionally, the external link detection circuit may include capacitive coupling, which blocks the LAN silicon's MDI common-mode voltage from impacting the signal detect operation. The high input impedance of the external link detection circuit may prevent excessive loading on MDI signals and thus, the circuit does may not affect signal integrity on the link.

Thus, a method and apparatus for power management in a peripheral device has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A peripheral device comprising:
an integrated circuit to detect when the integrated circuit is disconnected from a transmission medium, and to generate a disconnect signal indicating that the integrated circuit is disconnected from the transmission medium, the disconnect signal causing the integrated circuit to be powered off; and
an energy detection circuit to detect when the transmission medium is reconnected to the integrated circuit, and to generate a connect signal indicating that the integrated circuit is connected to the transmission medium, the connect signal causing the integrated circuit to be powered on.

2. The peripheral device of claim 1 wherein:
the integrated circuit comprises a connection detection circuit to detect when the integrated circuit is disconnected from the transmission medium; and
the energy detection circuit to detect when the integrated circuit is reconnected to the transmission medium.

3. The peripheral device of claim 2 wherein:
the energy detection circuit is part of the integrated circuit.

4. The peripheral device of claim 1 wherein:
the transmission medium comprises Ethernet protocol.

5. The peripheral device of claim 1 wherein:
the integrated circuit comprises a LAN controller.

6. The peripheral device of claim 1 wherein:
the energy detection circuit comprises a signal detector.

7. A method comprising:
receiving a first signal from an integrated circuit indicating that the integrated circuit is not connected to a transmission medium;
generating a second signal to power off the integrated circuit in response to the first signal;
receiving a third signal from an energy detection circuit indicating that the integrated circuit is reconnected to the transmission medium; and
generating a fourth signal to power on the integrated circuit in response to the third signal

8. The method of claim 7 wherein:
the integrated circuit comprises a connection detection circuit to detect when the integrated circuit is disconnected from the transmission medium, and the energy detection circuit to detect when the integrated circuit is reconnected to the transmission medium.

9. The method of claim 7 wherein:
the transmission medium comprises Ethernet protocol.

10. The method of claim 7 wherein:
the integrated circuit comprises a LAN controller.

11. A machine-readable medium containing instructions which, when executed by a processing system, cause the processing system to perform a method, the method comprising:
receiving a first signal from an integrated circuit indicating whether the integrated circuit is connected to a transmission medium;
powering off the integrated circuit if the first signal indicates that the integrated circuit is not connected to the transmission medium;
receiving a second signal from an energy detection circuit indicating whether the integrated circuit has been reconnected to the transmission medium; and
powering on the integrated circuit if the second signal indicates that the integrated circuit has been reconnected to the transmission medium.

12. The machine-readable medium of claim 11 wherein:
the integrated circuit comprises a connection detection circuit to detect when the integrated circuit is disconnected from the transmission medium, and the energy detection circuit to detect when the integrated circuit is reconnected to the transmission medium.

13. The machine-readable medium of claim 11 wherein:
the transmission medium comprises Ethernet protocol.

14. The machine-readable medium of claim 11 wherein:
the integrated circuit comprises a LAN controller.

15. A system comprising:
a peripheral device comprising an integrated circuit to generate a signal causing the integrated circuit to be powered off when the integrated circuit is not coupled to a transmission medium, and an energy detection circuit to generate a signal causing the integrated circuit to be powered on when the integrated circuit is re-connected to the transmission medium; and
a FLASH memory to store basic input/output system (BIOS) software associated with the peripheral device.

16. The system of claim 15 wherein:
the integrated circuit comprises a connection detection circuit to detect when the integrated circuit is disconnected from the transmission medium; and
the energy detection circuit to detect when the integrated circuit is reconnected to the transmission medium.

17. The system of claim 16 wherein:
the energy detection circuit is part of the integrated circuit.

18. The system of claim 15 wherein:
the transmission medium comprises Ethernet protocol.

19. The system of claim 15 wherein:
the integrated circuit comprises a LAN controller.

20. The system of claim 15 wherein:
the energy detection circuit comprises a signal detector.
